(19) United States
(12) Patent Application Publication
(10) Pub. No.: US 2003/0079107 A1
(43) Pub. Date: Apr. 24, 2003

(54) System and method for providing an interface for a repository

(75) Inventors: Paul Jonathan Booth, Penton Mewsey (GB); Roger John Colgate, Portsmouth (GB); Iain James Graf, London (GB); Christopher Mark Green, Romsey (GB); Philip Walsh, Bristol (GB); Ernest James Wilkins, Stockbridge (GB)

Correspondence Address: Gregory M. Doudnikoff, IBM Corporation, T81/503, PO Box 12195, Research Triangle Park, NC, 27709, US

(73) Assignee: International Business Machines Corporation, Armonk, NY (US)

(21) Appl. No.: 10/272,588

(22) Filed: Oct. 16, 2002

(30) Foreign Application Priority Data
Oct. 19, 2001 (GB) 0125164.4

(51) Int. Cl. G06F 15/00

(52) U.S. Cl. 712/1

(57) ABSTRACT

A system is described for providing at least one interface for a repository (102). A first interface (304) is provided with a plurality of objects (502), each object (502) representing an entity or group of entities for which there is metadata (306) provided in the repository (102). A means for selecting an object (502) in the first interface (304) provides access to the relevant metadata (306) in the repository (102). The first interface (304) represents a metamodel of the repository (102). The first interface (304) also has a plurality of lines (504) joining the objects, each line representing a relationship between the entities or group of entities represented by the objects (502) and a means for selecting a line (504) provides access to relevant metadata (306) in the repository (102) relating to the relationship represented by the line (504). The system may also have at least one second interface (312, 318, 322, 326, 331) which provides access to one or more levelled architectural diagrams relating to a sub-set of the metadata (306) of the repository (102). The selection of an object in a second interface (312, 318, 322, 326, 331) provides a next level of diagram with further objects for selection thereby providing different views of the sub-set and further sub-sets of the metadata (306) of the repository (102).

### BACKGROUND OF THE INVENTION

1. Field of the Invention

The present invention relates to a system and method for providing an interface for a repository. In particular, the invention relates to providing an interface based on a metamodel for a repository in a computer system.

2. Discription of the Related Art

A repository in a computer system is a collection of information about the computer system. A repository holds software, engineering and related data. A metamodel is a conceptual schema for a repository which is a tool used when building a repository.

Managing an organisation's data assets has become increasingly important, as computer systems have become more diverse, distributed and complex.

A repository is used to record and manage the information about the data models and the designs and implementations of databases, applications and hardware of a computer system. In other words, the repository records and manages metadata (data about data) of a computer system. The term computer system is used to include any arrangement of computers which may be distributed by a network such as an organisation's intranet or the Internet, a stand-alone computer or any other arrangement.

The aim of the repository is to provide an integrated and manageable information resource for a computer system. A repository is used to integrate different independent databases, user applications, reference and directory management systems, systems administration, etc. to present a single, consistent view of the metadata describing the computer system. A repository can manage business rules as well as physical data elements which apply in an organisation.

Reference is made to “Platinum Enterprise Repository Strategy” by Computer Associates International, Inc, 2000, www.platinum.com/products as an example of repository technology.

Organisations may have large suites of legacy applications which are applications that remain in use after the organisation has installed new systems. Organisations with large suites of legacy applications often have difficulties in understanding the overall picture of how the applications interface with each other and the technical implementation of the applications. This results in a slowing of reaction time and increased costs for making changes that affect more than one application. This also inhibits architectural control over application developers resulting in inconsistent technical implementations.

Repository information is complex and users often have problems in understanding and agreeing the scope and structure of the repository contents and then in locating a particular piece of information in the repository.

It is an aim of the present invention to provide a means of navigating metadata in a repository. It is also an aim of the present invention to assist with the establishment of architectural control over suites of legacy applications.

Entity Relationship Attribute (ERA) models and matrices are standard industry tools which are used in the present invention. It is known to use ERA models in business models for business data.

### SUMMARY OF THE INVENTION

According to a first aspect of the present invention there is provided a system for providing at least one interface for a repository, the system comprising: a first interface having a plurality of objects, each object representing an entity or group of entities for which there is metadata provided in the repository, means for selecting an object thereby providing access to the relevant metadata in the repository, wherein the first interface represents a metamodel of the repository.

Preferably, the first interface also has a plurality of lines joining the objects, each line representing a relationship between the entities or group of entities represented by the objects. The system may include a means for selecting a line thereby providing access to relevant metadata in the repository relating to the relationship represented by the line.

The objects may include an associated list of attributes relating to the entity or group of entities represented by the objects. The lines may have an associated list of attributes relating to the relationship represented by the lines.

The first interface may use entity relationship attribute models and matrices.

Preferably, at least one second interface is provided with each second interface including access to one or more levelled architectural diagrams relating to a sub-set of the metadata of the repository. The selection of an object in a second interface may provide a next level of diagram with further objects for selection thereby providing different views of the sub-set and further sub-sets of the metadata of the repository.

According to a second aspect of the present invention there is provided a repository with at least one interface comprising: storage means for metadata relating to a computer system; a first interface having a plurality of objects, each object representing an entity or group of entities for which there is metadata stored in the repository; means for selecting an object thereby providing access to the relevant metadata in the repository; wherein the first interface represents a metamodel of the repository.

Preferably, the first interface also has a plurality of lines joining the objects, each line representing a relationship between the entities or group of entities represented by the objects. The system may include a means for selecting a line thereby providing access to relevant metadata in the repository relating to the relationship represented by the line.

The objects may include an associated list of attributes relating to the entity or group of entities represented by the objects. The lines may have an associated list of attributes relating to the relationship represented by the lines.

The first interface may use entity relationship attribute models and matrices.

Preferably, at least one second interface is provided, each second interface including access to one or more levelled architectural diagrams relating to a sub-set of the metadata of the repository. The selection of an object in a second interface may provide a next level of diagram with further objects for selection thereby providing different views of the sub-set and further sub-sets of the metadata of the repository.

According to a third aspect of the present invention there is provided a method for navigating a repository, the method including: providing a first interface for the repository, the first interface representing a metamodel of the repository and having a plurality of objects representing an entity or group of entities for which there is metadata provided in the repository; selecting an object in the first interface; providing access to the metadata in the repository relating to the entity or group of entities represented by the object.

Preferably, the first interface also has a plurality of lines joining the objects, each line representing a relationship between the entities or group of entities represented by the objects and the method includes selecting a line in the interface, providing access to the metadata in the repository relating to the relationship.

The method may include displaying an associated list of attributes for an object, the attributes relating to the entity or group of entities represented by the object. The method may include displaying an associated list of attributes for a line relating to the relationship represented by the line.

Preferably, the method includes providing at least one second interface, accessing one or more levelled architectural diagrams relating to a sub-set of the metadata of the repository via the second interface. The method may include selecting an object in a second interface provides to access a next level of diagram with further objects for selection thereby providing different views of the sub-set and further sub-sets of the metadata of the repository.

According to a fourth aspect of the present invention there is provided a computer program product stored on a computer readable storage medium, comprising computer readable program code means for navigating a repository, the code means performing the steps of: providing a first interface for the repository, the first interface representing a metamodel of the repository and having a plurality of objects representing an entity or group of entities for which there is metadata provided in the repository; selecting an object in the first interface; providing access to the metadata in the repository relating to the entity or group of entities represented by the object.

### BRIEF DESCRIPTION OF THE DRAWINGS

An embodiment of the present invention will now be described by way of example only with reference to the accompanying drawings, in which:

FIG. 1 is a schematic diagram of a system in accordance with the present invention;

FIG. 2 is a diagram of an architectural overview of metadata in accordance with the present invention;

FIG. 3 is a schematic diagram of levelled interfaces and metadata of a repository in accordance with the present invention;

FIG. 4 is a diagram of a first interface for a repository in accordance with the present invention;

FIG. 5A is a diagram of a second interface for a repository with a first selection in accordance with the present invention; and

FIG. 5B is a diagram of the second interface of FIG. 5A with a second selection.

### DESCRIPTION OF THE PREFERRED EMBODIMENT

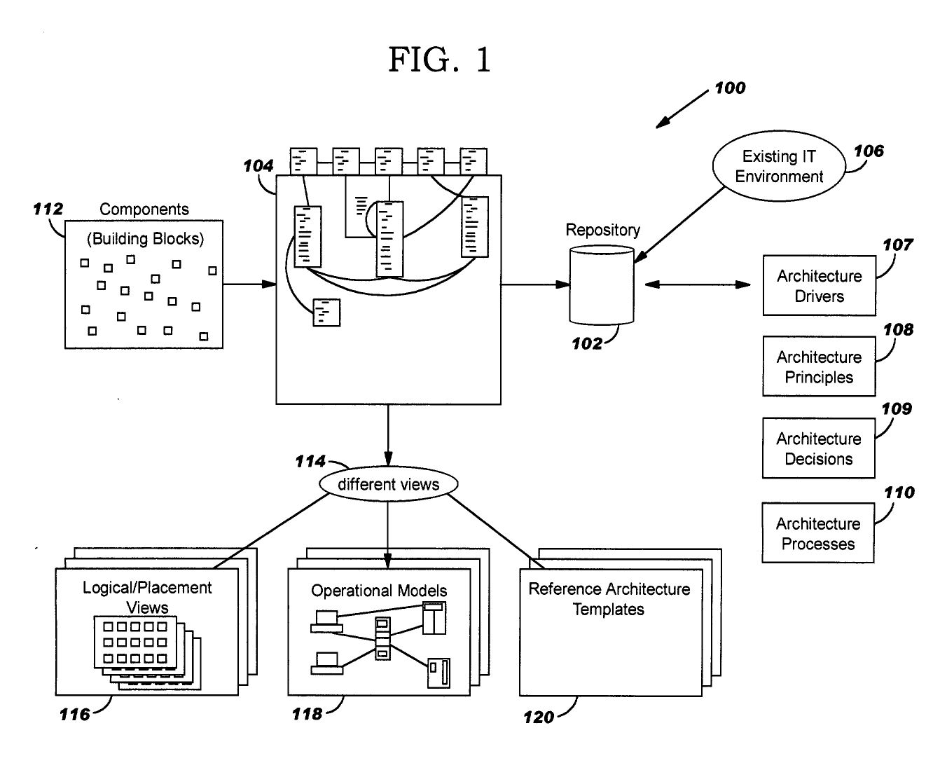

FIG. 1 illustrates the architectural overview of a computer system 100. The term computer system is used in its broadest sense to include any form of arrangement of computer components, including networked distributed computers which are connected via a local network, an intranet or the Internet. The architecture of a computer system is the physical construction or design of the computer system and its components.

The computer system 100 has a repository 102 which is a form of database containing metadata relating to the computer system. Data relating to an existing information technology environment 106 is included in the repository 102. Also included in the repository 102 is data relating to, for example, architecture drivers 107, architecture principles 108, architecture decisions 109 and architecture processes 110.

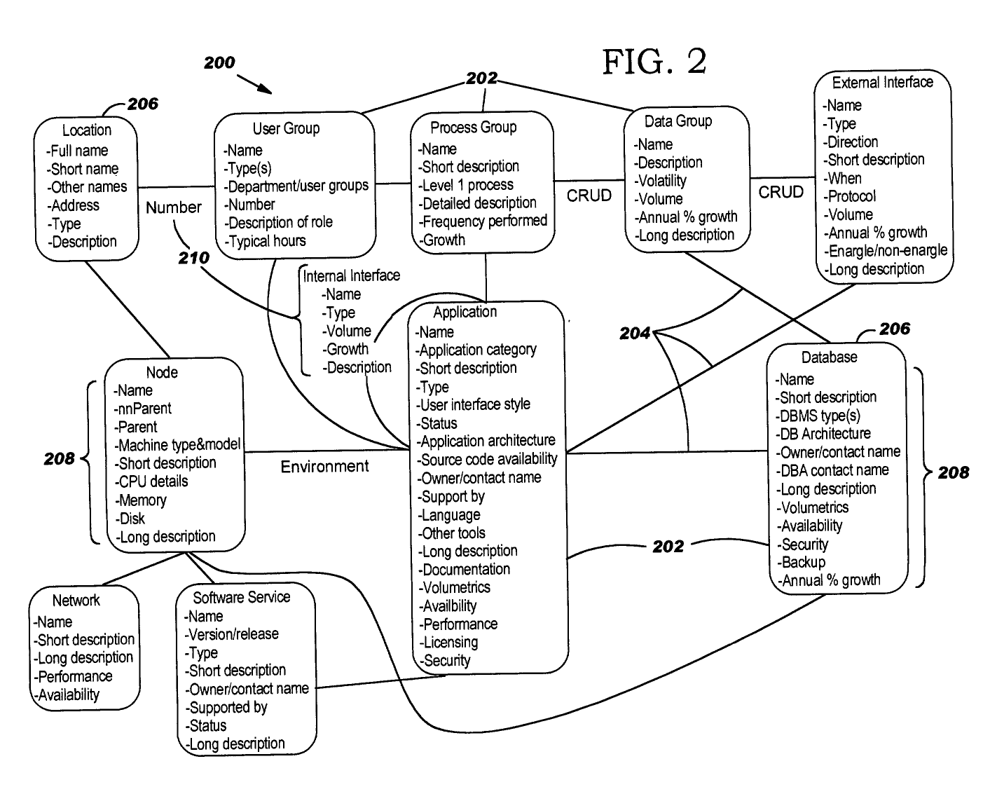

A metamodel 104 is formed for the repository 102 which provides details of an architectural overview of the metadata held in the repository 102. Further details of the categories of the metadata defined in the metamodel 104 are given in the discussion of FIG. 2 below which is shows an embodiment of a metamodel 104.

The components shown in the metamodel 104 are physically provided in the computer system 100 by physical components represented as building blocks 112 in FIG. 1. These include the hardware and software components, network arrangements, databases, etc.

The metamodel 104 is used in the described system as an interface to the repository 102 and the data referred to by metadata in the repository 102. The metamodel 104 can be represented in a plurality of interfaces with different views 114 of the repository 102. The interfaces can include logical/placement views 116, for example of the Web, a host program, a server and a personal desktop. The interfaces can also include operational models 118 and reference architecture templates 120.

FIG. 2 is a diagram of a metamodel 200 of a repository. The notation used is a simplified, industry standard ERA (Entity Relationship Attribute). Each ellipse 202 represents an entity about which data needs to be stored. Each ellipse 202 has a title 206 defining the entity represented by the ellipse 202. Each line 204 joining ellipses 202 represents a relationship between entities. The ellipses 202 and lines 204 are annotated with attributes 208, 210 relating to the entities or the relationships represented by the lines 204.

Data is stored in a repository which is tailored to reflect the metamodel 200 as illustrated in FIG. 2. Entities are stored as forms and relationships are stored as lists of occurrences of paired entities and, where appropriate, in matrix form.

The metamodel 200 contains entities relating to technical architecture of the computer system. These entities are represented by ellipses 202 such as the ellipses 202 with titles 206 “Node”, “Application”, “Database”, “Network”, “Software Service” and “External Interface”. Most of the titles are self-explanatory. “Node” refers to hardware components in the computer system and the attributes 208 may include a name of the component and its inter-relation to other components, a machine type and model, a short description, processor, memory disk storage details and a long description. “Application” refers to software application programs available in the computer system and “Database” refers to database programs provided in the computer system.

The metamodel 200 also contains entities relating to business models supported by the computer system. These entities are represented by ellipses 202 such as the ellipses 202 with titles 206 “Location”, “User Group”, “Process Group” and “Data Group”. For example, the ellipse 202 with title 206 “User Group” may contain data relating to the personnel user information with attributes 208 such as the name of the user group, type of user, the department/business group, the number of users in the group, a description of the users' role and typical hours. Another example, is the ellipse 202 with title 206 “Process Group” which may contain attributes 208 relating to the business processes including a name, different forms of descriptions, the frequency the process is performed, growth, etc.

The lines 204 representing relationships between entities can also represent internal relationships within an entity. For example, the entity “Application” has an internal interface represented by a line 204 with attributes 210 such as name, type, volume, growth and description.

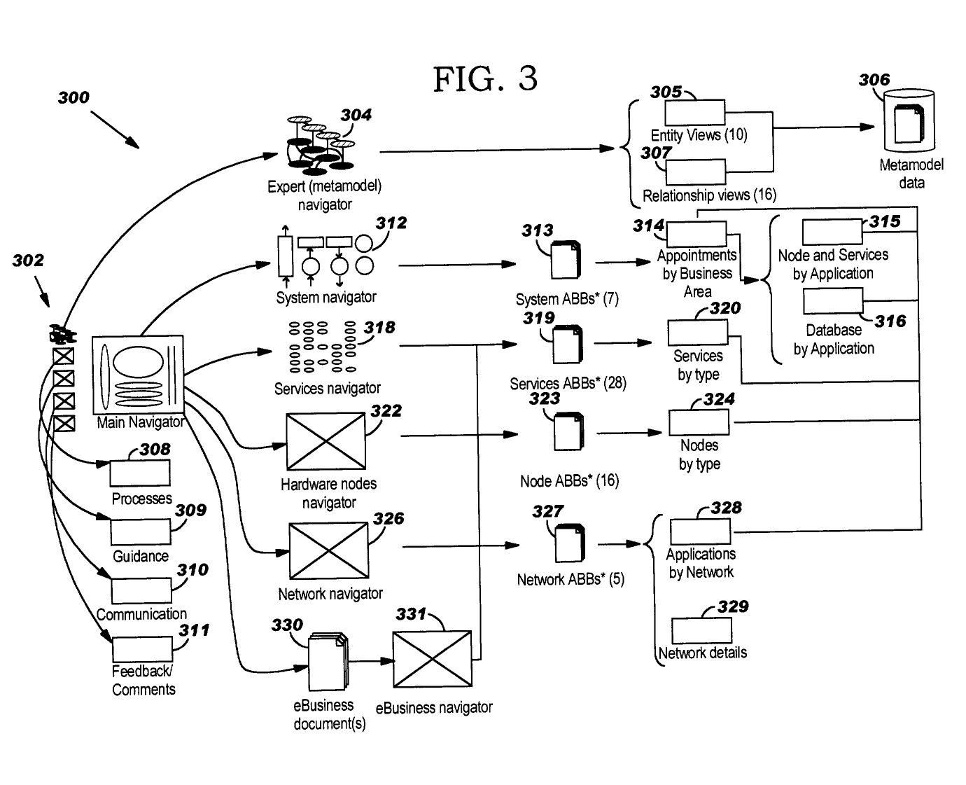

The metamodel 200 is used as an interface to navigate the metadata in the repository and the data referred to by the repository. Embodiments of the interfaces are described below with reference to FIG. 3.

FIG. 3 is a schematic representation of a route map 300 to the repository which shows the plurality of interfaces which can be provided in accordance with the present invention. The interfaces provide means for navigating the metadata in the repository.

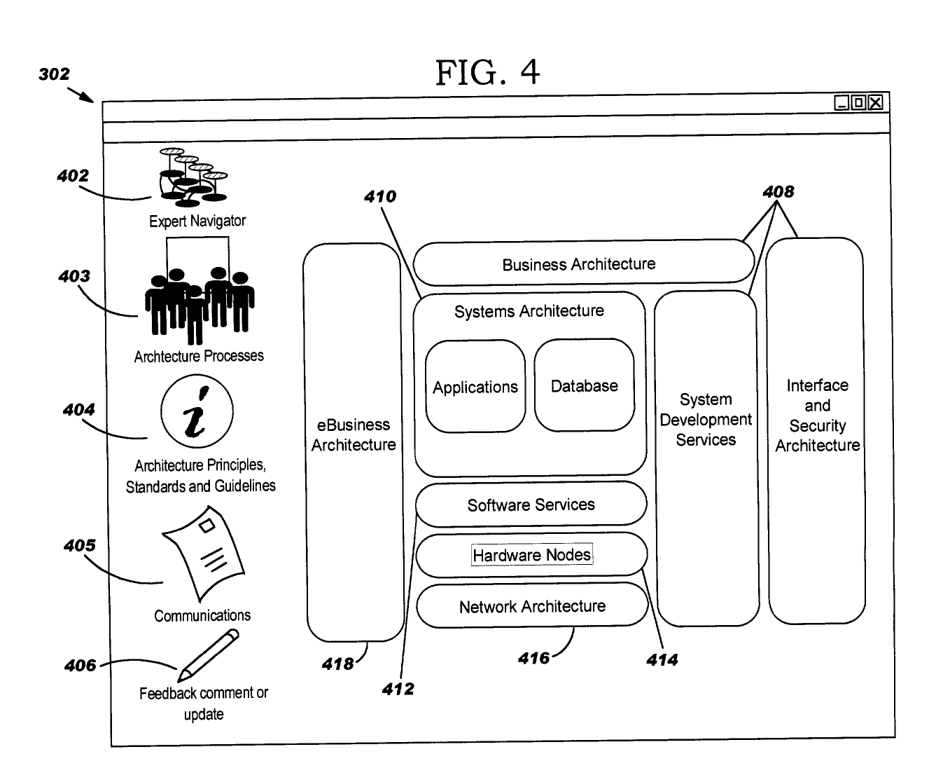

A main navigator interface 302 is provided. The main navigator interface 302 is shown in more detail in FIG. 4. As FIG. 4 shows, the main navigator interface 302 is provided as a graphical user interface on a computer display. Means for moving around the display, pointing to and selecting objects on the display is provided by an input mechanism such as a computer mouse, digital pen, keyboard, etc.

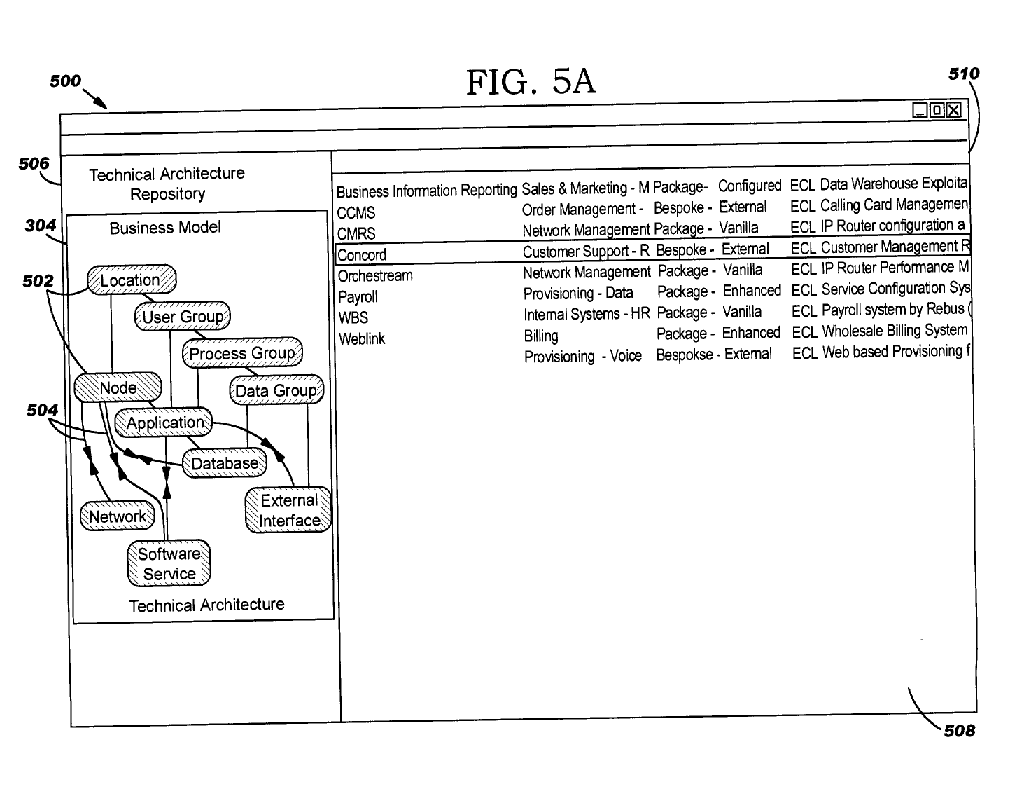

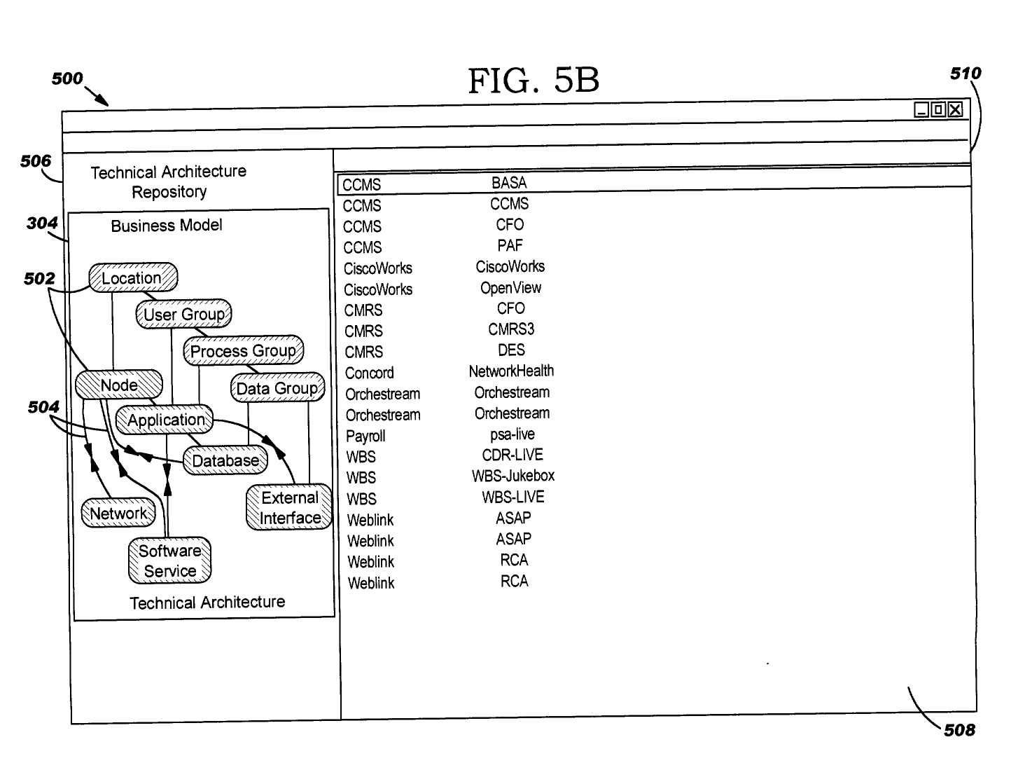

The main navigator interface 302 has a number of graphic symbols 402-406, one of which 402 identifies a metamodel navigator interface 304. The metamodel navigator interface 304 is shown in detail in FIGS. 5A and 5B and includes a plurality of entities represented by ellipses 502. The metamodel navigator interface 304 mirrors the content of the metamodel of FIG. 2. Selecting an ellipse 502 in the metamodel navigator interface 304 provides a view 305 of the entity in the form of information from the metadata 306 of the repository with attribute information relating to the entity. The metamodel navigator interface 304 also includes lines 504 joining the ellipses 502, the lines 504 representing relationships between the entities. Selecting a line 504 provides a view 307 of the relationship in the form of information retrieved from the metadata 306 of the repository.

The other graphic symbols 403-406 in the main navigator interface 302 identify tools relating to the main navigator interface 302, including architectural processes, architectural principles, standards and guidelines, communications and feedback comments and updates. Each of these graphic symbols 403-406, if selected in the main navigator interface 302, provides access to files 308-311 containing information on the tools.

The main navigator interface 302 also has a number of blocks 408 which, if selected, provide access to other interfaces to subsets of the metadata 306 of the repository. The blocks 408 relate to the hardware and software components of the computer system and to business and security systems.

One of the blocks 408 represents systems architecture 410 and, if this block 410 is selected, an interface in the form of a system navigator interface 312 will be displayed. The system navigator interface 312 provides a navigator interface for the metadata 306 of the repository relating to the software applications and databases of the computer system. Architectural building blocks 313 are used to build up a picture of the software applications and databases and these are sorted in different ways. The applications are sorted by business area 314 with a sub-sorting of nodes and services by application 315 and databases by application 316 each with access to the relevant metadata 306 from the repository.

The block 410 representing systems architecture has sub-blocks 411, 413 relating to the sub-sets of applications and databases within the systems architecture.

Another block 412 of the main navigator interface 302 represents software services. If this block 412 is selected, a services navigator interface 318 is displayed. Architectural building blocks 319 are used for different categories and groups of services. The services are also sorted by type 320 thereby providing easy location of specific metadata 306 in the repository relating to a type of service provided in the computer system.

A further block 414 of the main navigator interface 302 represents hardware nodes in the computer system. If this block 414 is selected, a hardware nodes navigator interface 322 is displayed. Architectural building blocks 323 representing each node are used and are sorted by type 324. This provides a means for location of metadata 306 in the repository relating to a hardware node.

Yet another block 416 of the main navigator interface 302 represents network architecture of the computer system. If this block 416 is selected, a network navigator interface 326 is displayed. Architectural building blocks 327 are used to represent the network components. The network information is further provided in applications by network 328 and network details 329 which reference the metadata 306.

Business processes and architectures can also be used as navigation tools to the metadata 306 in the repository. An example is provided by block 418 of the main navigator interface 302 which represents e-business architecture. If this block 418 is selected, e-business documents 330 are displayed and an e-business navigator interface 331 is provided. The e-business navigator interface 331 provides direction to specific services architectural building blocks 319 which can be used to access the relevant metadata 306 in the repository relating to the e-business documents 330.

As shown in FIG. 3, different interfaces 304, 312, 318, 322, 326, 331 are provided with different views of the repository. The main navigator interface 302 shown in FIG. 4 is a top level diagram of a levelled architectural diagram which is used as an interface and a navigator to the metadata stored in the repository.

By selecting a block 408 in the top level diagram 302, another lower level diagram associated with that block is presented for selection. Multiple levels of diagram can be provided. The bottom level diagram displays a list of the associated entities.

The different level diagrams cover different parts of the metamodel such as systems, databases, software, hardware and networks or a topic across the metamodel such as e-business, security. Associated policies, standards and strategies are also stored with the levelled diagrams.

It is possible to import hardware node data into the repository from a hardware configuration management tool and to export data from the repository to spreadsheets to enable matrices and business graphics to be generated.

The expert navigator interface 304 provides a view which mirrors the metamodel shown in FIG. 2. The expert navigator interface 304 is shown in FIGS. 5A and 5B. By selecting an ellipse 502 in the expert navigator interface 304, a user will be presented with all the occurrences of the entity for further selection. Similarly by selecting a line 504, the user will be presented with a list of all the occurrences of the relationship represented by the line 504. The user can then select the relationship itself or either of the paired entities involved in the relationship.

Referring to FIGS. 5A and 5B, a graphical user interface 500 is shown with a window 506 containing the expert navigator interface 304. An adjacent window 508 in the graphical user interface 500 contains details of the selected entity or relationship represented by the ellipses 502 and lines 504.

In FIG. 5A, the ellipse 502 with the title “Application” has been selected in the expert navigator interface 304. The adjacent window 508 displays information listing the applications together with information on the attributes 510 of the applications. The order of the listed information can be changed using conventional graphical user interface tools. An application of interest from the list can be selected.

In FIG. 5B, the line 504 joining the ellipse 502 with the title “Application” and the ellipse 502 with the title “Database” has been selected. The adjacent window 508 displays a list of applications 512 and a list of databases 514 used or accessed by each listed application.

In this way, any entity or relationship can be selected and the relevant metadata is accessed from the repository and displayed in the adjacent window 508.

Examples of software programs which can be used for a repository system include Lotus Notes (Notes is a trademark of IBM Corp.), Access (Access is a trademark of Microsoft Corp.), and other database management systems.

Entity Relationship Attribute (ERA) models and matrices are standard industry tools which are used in the described system. It is known to use ERA models in business models for business data. The described system uses ERA models with metadata. Metadata repositories are in use across the industry; however they do not surface the underlying metamodel as a navigation aid. The described system provides a combination of metamodelling with repository technology in order to provide easy access to applications architecture data and standards to all users of the applications and other repository information.

The combination of the conceptual view as a navigator to the underlying metamodel content allows the user to understand better how the architecture is built, not merely as a list of components. The provision of multiple conceptual views leading to the same repository content caters for different users' subjective view of what “architecture” means, without duplicating the information in the repository. This results in improved data accuracy and better architectural decisions.

The metamodel can be used as a means of discussing and agreeing, with stakeholders in a legacy application suite, the data about the applications that needs to be stored in a repository. A repository can then be built to physically store that data and provide access to it with a variety of views, including one mirroring the metamodel, to satisfy the needs of the different stakeholders.

As well as being rigorous, metamodels can be presented in such a way as to be understandable by business as will as information technology people. This is achieved by walking the stakeholders through the model, starting with the “top line” which represents the business and moving on to the “bottom line” which represents the implementation of the applications that support the business.

As well as a single company's legacy application suite, the repository can also be used to compare and contrast the application suites of merging companies in order to improve the application dispositioning decision making progress (i.e. retain both, retain one, replace both).

The present invention is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

Modifications and improvements may be made to the foregoing without departing from the scope of the present invention.

1. A system for providing at least one interface for a repository, the system comprising:
a first interface having a plurality of objects, each object representing an entity or group of entities for which there is metadata provided in the repository,
means for selecting an object thereby providing access to the relevant metadata in the repository, wherein the first interface represents a metamodel of the repository.

2. A system as claimed in claim 1, wherein the first interface also has a plurality of lines joining the objects, each line representing a relationship between the entities or group of entities represented by the objects.

3. A system as claimed in claim 2, wherein the system includes a means for selecting a line thereby providing access to relevant metadata in the repository relating to the relationship represented by the line.

4. A system as claimed in claim 1, wherein the objects include an associated list of attributes relating to the entity or group of entities represented by the objects.

5. A system as claimed in claim 2, wherein the lines have an associated list of attributes relating to the relationship represented by the lines.

6. A system as claimed in claim 1, wherein the first interface uses entity relationship attribute models and matrices.

7. A system as claimed in claim 1, wherein at least one second interface is provided each second interface including access to one or more levelled architectural diagrams relating to a sub-set of the metadata of the repository.

8. A system as claimed in claim 7, wherein the selection of an object in a second interface provides a next level of diagram with further objects for selection thereby providing different views of the sub-set and further sub-sets of the metadata of the repository.

9. A repository with at least one interface comprising:
storage means for metadata relating to a computer system;
a first interface having a plurality of objects, each object representing an entity or group of entities for which there is metadata stored in the repository;
means for selecting an object thereby providing access to the relevant metadata in the repository; wherein the first interface represents a metamodel of the repository.

10. A repository as claimed in claim 9, wherein the first interface also has a plurality of lines joining the objects, each line representing a relationship between the entities or group of entities represented by the objects.

11. A repository as claimed in claim 10, wherein the system includes a means for selecting a line thereby providing access to relevant metadata in the repository relating to the relationship represented by the line.

12. A repository as claimed in claim 9, wherein the objects include an associated list of attributes relating to the entity or group of entities represented by the objects.

13. A repository as claimed in claim 10, wherein the lines have an associated list of attributes relating to the relationship represented by the lines.

14. A repository as claimed in claim 9, wherein the first interface uses entity relationship attribute models and matrices.

15. A repository as claimed in claim 9, wherein at least one second interface is provided each second interface including access to one or more levelled architectural diagrams relating to a sub-set of the metadata of the repository.

16. A repository as claimed in claim 15, wherein the selection of an object in a second interface provides a next level of diagram with further objects for selection thereby providing different views of the sub-set and further sub-sets of the metadata of the repository.

17. A method for navigating a repository, the method including:
providing a first interface for the repository, the first interface representing a metamodel of the repository and having a plurality of objects representing an entity or group of entities for which there is metadata provided in the repository;
selecting an object in the first interface;
providing access to the metadata in the repository relating to the entity or group of entities represented by the object.

18. A method as claimed in claim 17, wherein the first interface also has a plurality of lines joining the objects, each line representing a relationship between the entities or group of entities represented by the objects and the method includes selecting a line in the interface, providing access to the metadata in the repository relating to the relationship.

19. A method as claimed in claim 17, wherein the method includes displaying an associated list of attributes for an object, the attributes relating to the entity or group of entities represented by the object.

20. A method as claimed in claim 18, wherein the method includes displaying an associated list of attributes for a line relating to the relationship represented by the line.

21. A method as claimed in claim 17, wherein the method includes providing at least one second interface, accessing one or more levelled architectural diagrams relating to a sub-set of the metadata of the repository via the second interface.

22. A method as claimed in claim 21, wherein the method includes selecting an object in a second interface provides to access a next level of diagram with further objects for selection thereby providing different views of the sub-set and further sub-sets of the metadata of the repository.

23. A computer program product stored on a computer readable storage medium, comprising computer readable program code means for navigating a repository, the code means performing the steps of:
providing a first interface for the repository, the first interface representing a metamodel of the repository and having a plurality of objects representing an entity or group of entities for which there is metadata provided in the repository;
selecting an object in the first interface;
providing access to the metadata in the repository relating to the entity or group of entities represented by the object.
